(19) United States
(12) Patent Application Publication
(10) Pub. No.: US 2023/0325817 A1
(43) Pub. Date: Oct. 12, 2023

(54) APPLICATION AND MOBILE POINT OF SALE SYSTEM ENABLING REAL TIME CONVERSION AND INTEROPERABILITY BETWEEN CRYPTOCURRENCY AND FIAT FOR POINT OF SALE TRANSACTIONS

(71) Applicant: FirstPayment Inc., Toronto (CA)

(72) Inventors: Alexandre Décarie, Beaconsfield (CA); Alexei Chirokikh, Montreal (CA); Jeffrey Paul Hill, La Jolla, CA (US)

(21) Appl. No.: 18/298,750

(22) Filed: Apr. 11, 2023

Related U.S. Application Data
(60) Provisional application No. 63/329,594, filed on Apr. 11, 2022.

(51) Int. Cl. G06Q 20/38; G06Q 20/20; G06Q 20/32; G06Q 20/36; G06Q 20/40; G06Q 20/10

(52) U.S. Cl. CPC G06Q 20/381; G06Q 20/204; G06Q 20/3274; G06Q 20/3221; G06Q 20/3678; G06Q 20/40; G06Q 20/10; G06Q 2220/00

(57) ABSTRACT

A cryptocurrency payments point-of-sale system and method for accepting cryptocurrency as a form of payment is provided. A system and method containing a POS application executed on a smart device for capturing, through a GUI from the POS application displayed on the smart device, payment information in the first type of currency. The POS application generates and displays a QR code. A consumer scans the QR code via a smart device using a digital wallet operating in the second type of currency. Crypto conversion banks coupled to a bank account for the merchant and to the digital wallet from the consumer via the POS application for converting the payment from the second type of currency into the first type of currency, authorizing a transaction and transferring funds from the second type of currency from the digital wallet to the bank account for the merchant in the first type of currency.

### FIELD OF THE INVENTION

The present invention relates to a cryptocurrency payments point of sale (POS) system and method for accepting cryptocurrency as a form of payment. More specifically, the invention provides a POS system and method that allows merchants to accept cryptocurrency without taking on the associated risks, as settlements are made instantly.

### BACKGROUND

A cryptocurrency is a digital or virtual currency that is secured by cryptography, which makes it nearly impossible to counterfeit or double-spend. Cryptocurrency has become a popular means of payment due to its ease of use, security, and decentralization. However, merchants face significant risks when accepting cryptocurrency payments, including price volatility, fraud, and regulatory compliance. These risks have limited the adoption of cryptocurrency as a payment method, particularly among small and medium-sized businesses.

Moreover, cryptocurrency is not currently easy to trade for simple day-to-day financial transactions, such as paying for meals at a restaurant, paying for groceries or purchasing expensive items such as a car, because it requires both end users to accept this type of currency. This is due to the inherent complexity of a cryptocurrency payment and the inherent risk of volatility in the price of cryptocurrency.

The use of cryptocurrencies has gained significant traction in recent years. However, despite this growth, the adoption of cryptocurrencies as a payment option at the point-of-sale (POS) has been limited due to the lack of interoperability between cryptocurrency and traditional Federal International Accepted Tender (FIAT) payment systems. Furthermore, existing cryptocurrency payment solutions have failed to provide a seamless and reliable experience for merchants and consumers, resulting in limited adoption. Current payment processing systems typically require several steps and may take several minutes or even hours to process and confirm cryptocurrency payments. This delay can cause frustration for consumers and may lead to delayed processing of payments for merchants.

Furthermore, merchants lack a seamless, trustworthy and secure solution to accept cryptocurrencies as payment. The rise of different types of cryptocurrency is providing new channels for consumers to transact with merchants, adding to the complexity in effecting efficient currency conversion. Similarly, cryptocurrency owners need a reliable, secure, risk-free, cost effective widely adopted payments options to turn their assets into tangible goods.

To address these challenges, there is a need to provide a cryptocurrency payments POS system that allows merchants to accept cryptocurrency without taking on any risks, that integrates with existing payments hardware, automates merchant onboarding, provides machine learning for fraud risk monitoring and detection, and offers automated Know Your Customer (KYC)/Know Your Business (KYB)/Know Your Transaction (KYT) with fast merchant approval. There is a need for a system that offers blockchain loyalty and rewards for both merchants and consumers, automated KYT monitoring for cryptocurrency transactions in real time, and recurring cryptocurrency payments for subscription services/merchants that also integrates with the Lightning Network for instant payments and offers real-time fiat settlements for merchants once a crypto payment is authorized.

More specifically, there is a need for a mobile application and a mobile POS (mPOS) platform, which enables real-time conversion and interoperability between cryptocurrency and FIAT for point-of-sale transactions to accept seamlessly cryptocurrency at merchant's locations and a system to allow merchants to adopt cryptocurrency as a secure payment option, providing significant benefits to both merchants and consumers, that provides a reliable and seamless payment solution for merchants and consumers, enabling real-time conversion and interoperability between cryptocurrency and FIAT at the point of sale that both significantly benefit merchants and consumers, improving the overall experience and adoption of cryptocurrency as a payment option.

There is a need for a simple Point-of-Sale (POS) system that accepts in real-time cryptocurrency payments and converts in real-time the cryptocurrency into a currency of choice in order to facilitate cryptocurrency acceptance, eliminate risk and volatility while opening new markets to merchants. There is a need to save merchants money and settle transactions faster than the outdated credit card duopoly in order to open new markets to younger, more affluent consumers, increasing revenue potential while eliminating the costly and time-consuming chargebacks, fraud, and rolling reserve requirements that cost merchants billions of dollars annually. There is a need to fill consumers' desire to spend seamlessly their cryptocurrency at the point of sale in order to save them time and money compared to off ramping their cryptocurrency via exchanges and old-fashioned banks.

The term POS is used herein generically to refer to, but not limited to, point of sales and payment systems hardware and/or software. A POS application can be executed on a smart phone, a tablet, a computer, a wearable device, or POS specific payments hardware.

### BRIEF SUMMARY

It is an object of the invention to provide a cryptocurrency payments point of sale (POS) system and method for accepting cryptocurrency as a form of payment.

In accordance with an aspect of the invention, there is provided a system for facilitating conversion between a first type of currency used by a merchant and a second type of currency used by a consumer, comprising a POS application executed on a first smart device for capturing, by the merchant through a GUI from the POS application displayed on the first smart device, payment information in the first type of currency, the POS application generating and displaying a QR code via the GUI. The consumer scans the QR code via a second smart device using a digital wallet operating in the second type of currency. At least one crypto conversion bank coupled to a bank account for the merchant and to the digital wallet from the consumer via the POS application for converting the payment from the second type of currency into the first type of currency, authorizing a transaction and transferring funds from the second type of currency from the digital wallet to the bank account for the merchant in the first type of currency.

In accordance with another aspect of the invention, there is provided a method to facilitate conversion between a first type of currency used by a merchant and a second type of currency used by a consumer, comprising capturing, by the merchant through a GUI from a POS application executed on a first smart device, payment information in the first type of currency. Generating a QR code by the POS application. Displaying the QR code via the GUI. Scanning, by the consumer via a second smart device, the QR code using a digital wallet operating in the second type of currency. At least one crypto conversion bank coupled to a bank account for the merchant and to the digital wallet from the consumer via the POS application for converting the payment from the second type of currency into the first type of currency, authorizing a transaction, and transferring funds from the second type of currency from the digital wallet to the bank account for the merchant in the first type of currency.

In accordance with an embodiment of the invention, the first type of currency is a cryptocurrency, and the second type of currency is a traditional government emitted currency.

In accordance with an embodiment of the invention, a transaction fee is retained from the merchant when the transaction is authorized.

In accordance with an embodiment of the invention, a transaction fee is retained from the consumer when the transaction is authorized.

In accordance with an embodiment of the invention, the payment information comprises one or more of merchant information, consumer information and transaction documentation.

In accordance with an embodiment of the invention, the first smart device comprises one or more of a smartphone, tablet, wearable and a POS payment device.

In accordance with an embodiment of the invention, the second smart device comprises one or more of a smartphone, tablet, wearable and a POS payment device.

In accordance with an embodiment of the invention, the transaction is added to an independent software vendor.

In accordance with an embodiment of the invention, the transaction is added to one or more manufacturer's payment devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates an example graphical user interface in accordance with one embodiment.

FIG. 2 illustrates a system architecture in accordance with one embodiment.

FIG. 3 illustrates a workflow in accordance with one embodiment.

FIG. 4 illustrates an example graphical user interface in accordance with one embodiment.

FIG. 5 illustrates an example graphical user interface in accordance with one embodiment.

FIG. 6 illustrates an example graphical user interface in accordance with one embodiment.

FIG. 7 illustrates an example graphical user interface in accordance with one embodiment.

FIG. 8 illustrates an example graphical user interface in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

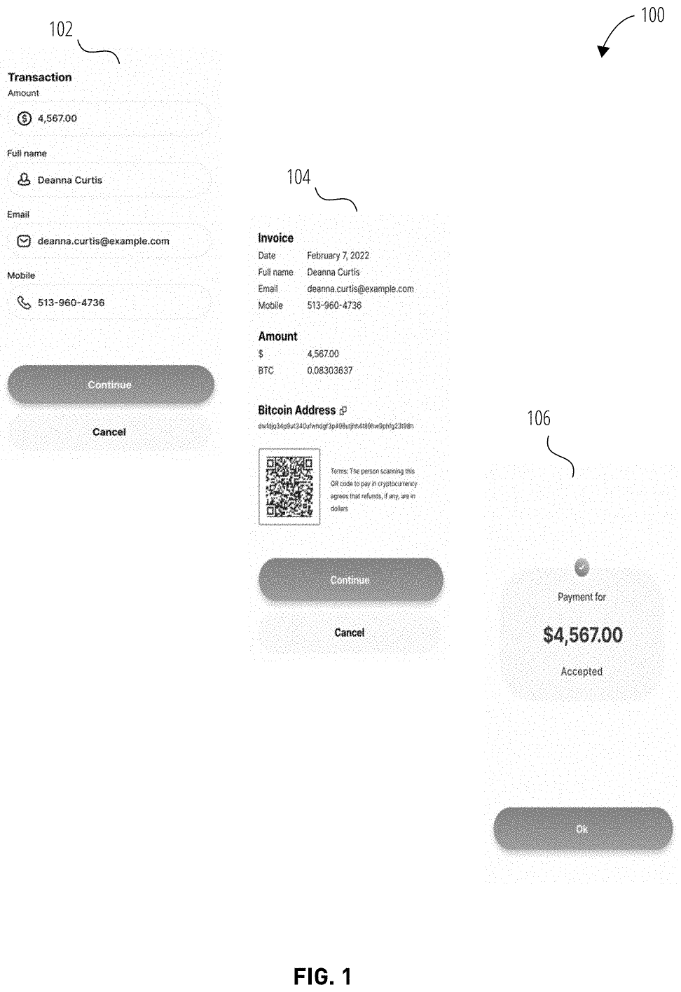

FIG. 1 depicts an example graphical user interface 100 for a POS application executed on a smart phone or tablet or on a POS device, according to some embodiments. As an example, transaction information 102 is entered on a first screen, for example using a consumer's digital wallet application. Transaction information 102 comprises payee information as well as any other information used to document the transaction. Then the conversion to cryptocurrency 104 is applied and a confirmation of payment 106 is shown when the transaction is affected. The system eliminates the risk of price volatility between the transaction is performed and the conversion of the currency. The system also allows for acceptance of most commonly traded cryptocurrencies. The system is also wallet agnostic.

In another embodiment, different types of cryptocurrency may be available and selected before the conversion to cryptocurrency 104. The system can be used to convert any cryptocurrencies to traditional currencies. In another embodiment, the system can be used to convert from one type of cryptocurrency to another type. In another embodiment, the system can accept traditional currency and convert it into a cryptocurrency used by the merchant.

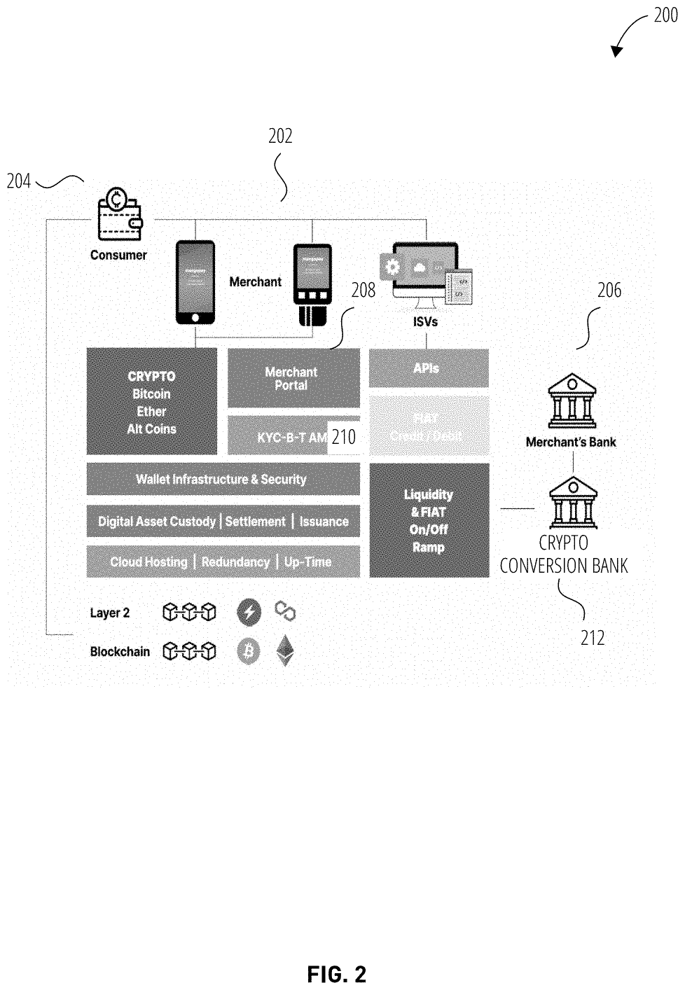

FIG. 2 depicts a system architecture 200, according to some embodiments. The system integrates payment and crypto solution to ensure usability, scalability, security, and reliability. Consumer 204 uses POS 202 to access the conversion system which implements different layers of security. The system consolidates all aspects of crypto payment management and workflow. Merchant portal 208 gives access to fast and easy merchant onboarding with necessary compliance requirements 210 such as, for example Know-your-Customer (KYC), Know-Your-Business (KYB), Know-Your-Transaction (KYT) and Anti-Money-Laundering (AML).

Merchants process transaction information 102 through a software application executed on a smartphone, tablet, wearable or a POS payment device. Crypto payment can also be added to an Independent Software Vendor (ISV) application and manufacturer's payment devices.

The system provides crypto wallet management, crypto transaction compliance (Know-You-Transaction-KYT) and transfer of cryptocurrency currency into the fiat currency of choice of the account from the merchant bank 206. In another embodiment, the system can be configured to accept fiat currency and automatically convert it into cryptocurrency. It can also be configured to accept a first type of cryptocurrency and automatically convert it into a second type of cryptocurrency, such as a traditional government emitted currency.

The system implements all required cybersecurity functionality to prevent threats and respond to security events. In another embodiment, the system retains a transaction fee when the transaction is authorized.

This system provides merchants an increase in revenue by opening new markets to younger, more affluent consumers, saves merchants money and settles faster than with the outdated credit card duopoly and eliminates costly and time-consuming chargebacks, fraud and rolling reserve requirements that cost merchants billions yearly.

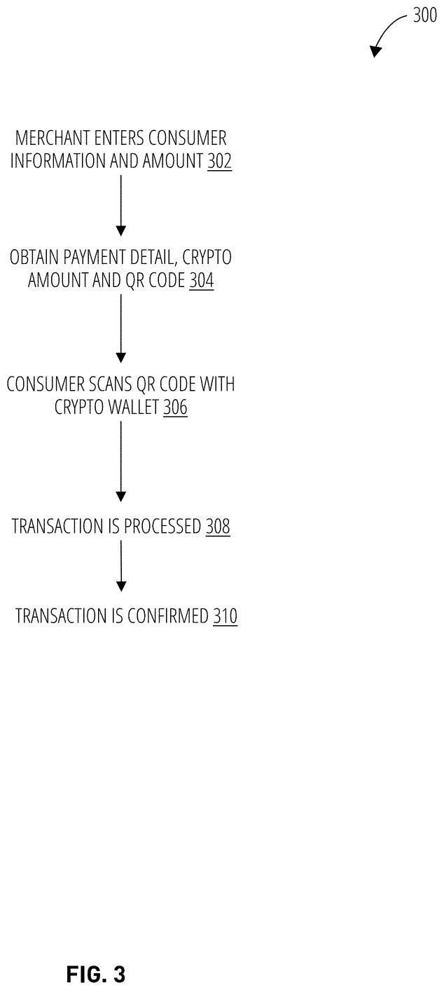

FIG. 3 presents an example workflow 300, according to some embodiments. The merchant enters consumer information and amount 302 in the application executed on POS 202. The application obtain payment detail, crypto amount and QR code 304 and displays on the POS 202 screen. The consumer scans QR code with crypto wallets 306 executed on its device (smart phone, wearable, tablet etc.). The transaction is processed 308 by the crypto conversion bank 212 in communication with the digital wallet of the consumer and with the merchant's bank. After all the authorizations are successful, the transaction is confirmed 310.

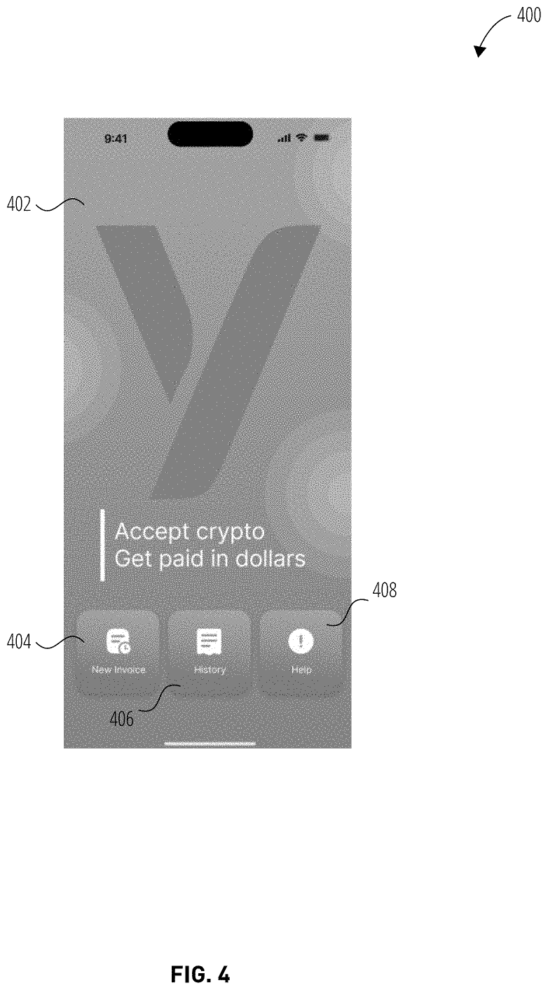

FIG. 4 depicts an example graphical user interface 400 for an POS application executed on a smart phone or tablet or on a POS device, according to some embodiments. In the figure provided, a home screen 402 is shown linking a merchant or consumer to create a new invoice 404, review their history 406 or request help 408 with the programs on the POS application.

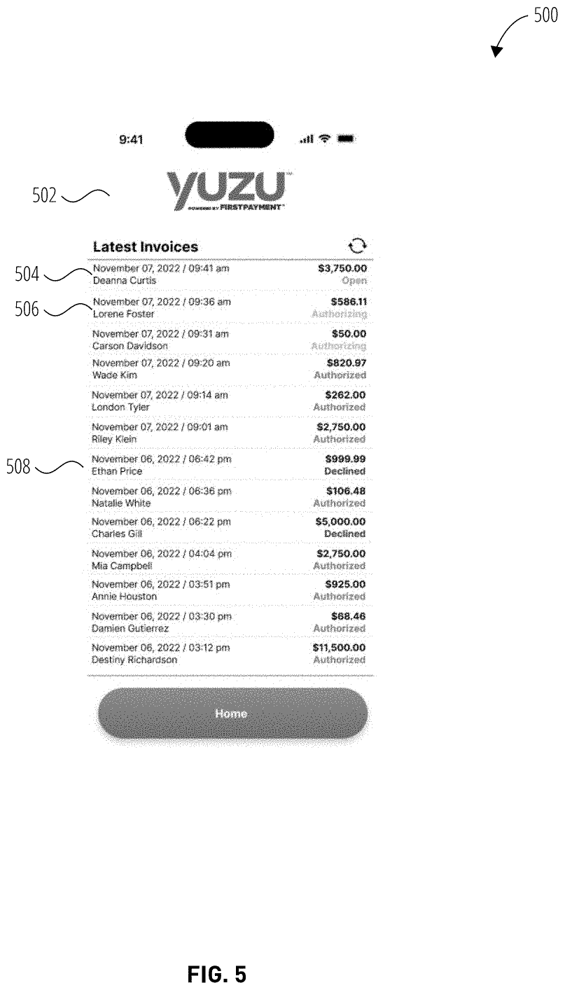

FIG. 5 depicts an example graphical user interface 500 for a POS application executed on a smart phone or tablet or on a POS device, according to some embodiments. In the figure provided, transaction history 502 is shown that provides the transaction history 502 of each invoice created for a merchant or consumer. In the example shown, the date and time, the information for the user involved in the transaction, the amount being transferred, and the transaction status is shown for each transaction in transaction history 502. The transaction statuses range from open transaction 504 or an ongoing transaction that is still being processed, authorized transaction 506 and declined transaction 508.

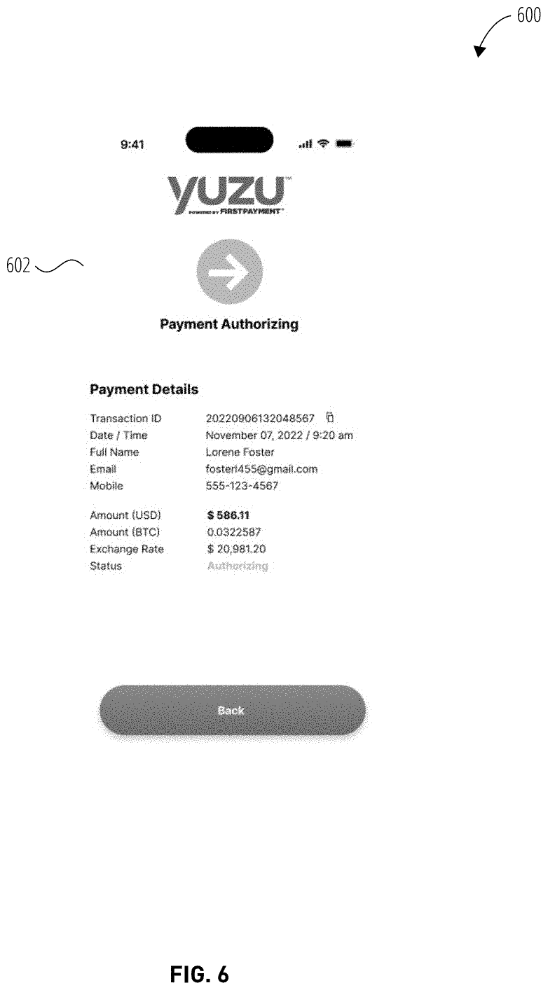

FIG. 6 depicts an example graphical user interface 600 for an POS application executed on a smart phone or tablet or on a POS device, according to some embodiments. In the figure provided, a further detail about a specific transaction that has the payment confirmation in progress 602 are shown. In the example shown, the transaction ID, the date and time, the information for the user involved in the transaction, the amount being transferred, the type of currency involved in the transaction, the currency exchange rate and the transaction status are shown.

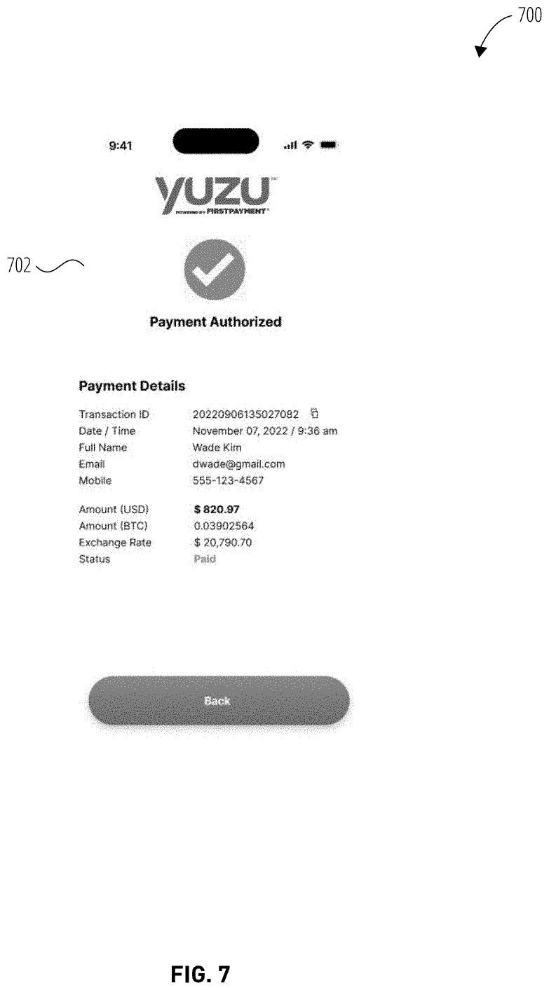

FIG. 7 depicts an example graphical user interface 700 for a POS application executed on a smart phone or tablet or on a POS device, according to some embodiments. In the figure provided, a further detail about a specific transaction that has payment confirmation 702 are shown. In the example shown, the transaction ID, the date and time, the information for the user involved in the transaction, the amount being transferred, the type of currency involved in the transaction, the currency exchange rate and the transaction status are shown.

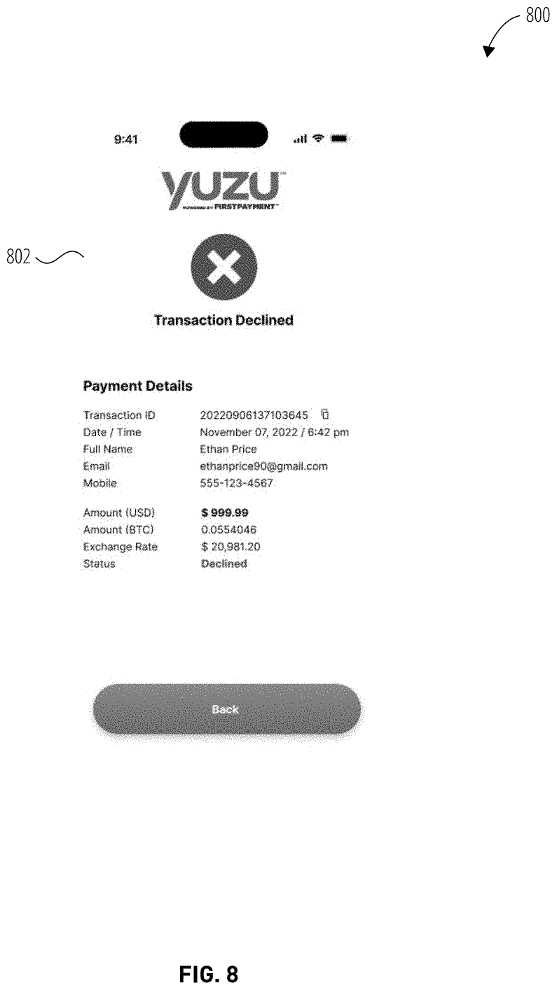

FIG. 8 depicts an example graphical user interface 800 for a POS application executed on a smart phone or tablet or on a POS device, according to some embodiments. In the figure provided, a further detail about a specific transaction that has the payment declined 802 are shown. In the example shown, the transaction ID, the date and time, the information for the user involved in the transaction, the amount being transferred, the type of currency involved in the transaction, the currency exchange rate and the transaction status are shown.

Real-Time Conversion and Interoperability Between Crypto and FIAT:

In some embodiments, a cryptocurrency payments point of sale (POS) platform allows to minimize dependency on the volatility of the cryptocurrency markets and ensures that merchants receive the amount of their invoice in real-time. Interoperability between crypto and fiat provides the ability of these two different types of currencies to work together seamlessly. In other words, it means that they can be used interchangeably without any friction or difficulty. Achieving interoperability is essential for the widespread adoption of cryptocurrencies, as it makes it easier for users to use them in their daily lives. A system and method for real-time conversion and interoperability between crypto and fiat payments is disclosed. The system allows for seamless transactions between cryptocurrency and fiat currency, utilizing real-time conversion rates to provide frictionless payment experience for users.

The system consists of a payment gateway that accepts both cryptocurrency and fiat currency payments. When a user initiates a transaction, the system automatically converts the cryptocurrency payment to its equivalent fiat currency value in real-time, using a third-party exchange rate. The system then settles the transaction in fiat currency with the merchant, ensuring a seamless transaction experience for both parties.

The system also allows for the conversion of fiat currency payments to cryptocurrency, providing users with the option to pay with either form of currency. The real-time conversion rates ensure that the user receives the most up-to-date value for their cryptocurrency payment.

In order to ensure security and compliance with regulations, the system utilizes secure storage and transmission protocols for all user data and transactions. The system also complies with all applicable anti-money laundering (AML) and know-your-customer (KYC) regulations.
The system provides several advantages over traditional payment methods, including Real-time conversion rates that ensure users receive the most up-to-date value for their cryptocurrency payments.
Interoperability between cryptocurrency and fiat currency, enabling seamless transactions between the two.
Secure storage and transmission of user data and transactions, ensuring compliance with all applicable regulations.
A frictionless payment experience for users, with no need for manual conversion or settlement processes.

The Real-Time Conversion and Interoperability Between Crypto and Fiat Payments Solution provides a unique and innovative approach to payments, addressing the need for seamless transactions between cryptocurrency and fiat currency. The system's real-time conversion rates and secure storage protocols ensure a frictionless payment experience for users, while complying with all applicable regulations.

Consumer Wallet Agnostic:

Consumers can connect any digital hot wallet containing cryptocurrency to a mobile cryptocurrency payments point of sale application (mPOS), eliminating the need for a two-sided app for merchants and consumers to transact. A consumer wallet agnostic approach aims to create a seamless and flexible payment experience for consumers by allowing them to use their preferred digital wallet or payment method to utilize the mPOS merchant application when making purchases or transactions. Being wallet agnostic, the mPOS can also increase customer satisfaction and loyalty since it offers customers the convenience and flexibility to pay using their preferred method, which can translate into more sales and revenue. A wallet-agnostic mPOS system is provided that enables merchants to accept various cryptocurrencies without the need for a specific wallet.

The present embodiment relates to a wallet-agnostic mobile cryptocurrency payments point of sale (mPOS) system that allows merchants to accept payments in various cryptocurrencies without the need for a specific wallet. The payment gateway facilitates secure transactions between customers and merchants, ensuring that payment details are encrypted and transmitted securely. The payment gateway also verifies the authenticity of the payment and confirms that the necessary funds are available for the transaction.

Crypto Custody for Merchants:

Merchants never take custody of the cryptocurrency and are not subject to holding cryptocurrency and the tax implications that it entails. Crypto custody for merchants typically involves using a third-party service trusted provider that specializes in digital asset custody. These providers offer secure storage solutions for merchants, including multi-signature wallets, hardware wallets, and cold storage. In the case of the POS platform, this feature is handled by platform functionality relying on a solution provided by one of the industry leaders in the crypto industry.

Overpayment and Underpayment Detection Process and Solution:

For in-person transactions at the point of sale, the ability to detect under and overpayment before the customer departs is critical. POS platform has implemented this feature by polling the blockchain to determine the instant funds arrive. Upon fund's arrival, POS platform compares the digital asset amount transferred by the customer to the amount being charged by the merchant. In some embodiments, the POS platform can identify an under or overpayment within 60 seconds of funds leaving the customer's wallet. This is a novel implementation, as waiting until funds confirm on the blockchain can take several minutes or hours.

The POS platform's process and solution for detecting overpayments and underpayments in cryptocurrency transactions is described. The system monitors cryptocurrency transactions and compares the amount sent to the expected payment amount. In the event of an overpayment or underpayment, the system automatically takes corrective action, such as refunding the overpayment or requesting additional payment to cover the underpayment.

Cryptocurrencies are a popular form of payment for online transactions, but they are not immune to payment errors. Overpayments and underpayments can occur due to errors in the payment process or fluctuations in cryptocurrency exchange rates. Currently, there is a need for a process and solution that can accurately detect and correct payment errors in cryptocurrency transactions.

The overpayment and underpayment detection process and solution described herein is a software-based system that utilizes blockchain technology to monitor cryptocurrency transactions. The system includes the following steps:
Payment Monitoring: The system monitors cryptocurrency transactions and records the payment amount and expected payment amount.
Comparison: The system compares the payment amount to the expected payment amount. If the payment amount exceeds the expected payment amount, an overpayment is detected. If the payment amount is less than the expected payment amount, an underpayment is detected.
Correction: In the event of an overpayment, the system automatically refunds the excess amount to the sender's cryptocurrency wallet. In the event of an underpayment, the system generates a payment request for the remaining amount due and sends it to the sender.
Reporting: The system generates reports of payment errors, including the number of overpayments and underpayments detected, as well as any corrective action taken.

The overpayment and underpayment detection process and solution described herein is applicable to a wide range of cryptocurrency payment systems, including those used for online transactions, e-commerce, and peer-to-peer payments.

The overpayment and underpayment detection process and solution described herein provides a reliable and automated method for detecting and correcting payment errors in cryptocurrency transactions. By utilizing blockchain technology, the system can ensure the accuracy and security of payments, while reducing the risk of fraud and errors. This process and solution represent a significant advancement in the field of cryptocurrency payments and has the potential to greatly enhance the efficiency and reliability of cryptocurrency transactions.

Consumer Payment “Near Real-Time” Notification:

As blockchain confirmation times vary with the level of real-time congestion on the blockchain, a busy merchant cannot be expected to monitor all active transactions resulting in a busy marketplace. The POS platform issues notifications to the merchant device for each critical change in transaction status. Each notification contains a Transaction ID (TID), timestamp, and new transaction state.

A system and method for providing near real-time notifications for consumer cryptocurrency payments is disclosed. The system includes a payment processing module configured to process consumer cryptocurrency payments, and a notification module configured to generate and send near real-time notifications to consumers upon completion of the payment transaction. The system provides an efficient and secure means for consumers to receive immediate confirmation of their cryptocurrency payments.

The disclosed system includes a payment processing module that is configured to receive and process cryptocurrency payments from consumers. The payment processing module may be implemented using blockchain technology or other secure and efficient payment processing systems. The system also includes a notification module that is configured to generate and send near real-time notifications to consumers upon completion of the payment transaction. The notification module may be implemented using SMS, email, push notifications, or other suitable means of communication.

The payment processing module and notification module may be integrated with existing payment processing systems used by merchants. In this way, merchants can receive near real-time confirmation of consumer payments and provide immediate feedback to consumers on the status of their payments. The system provides a more efficient and secure means for confirming cryptocurrency payments, which can improve the overall payment processing experience for consumers and merchants.

Payment Solution Integrating Lightning Network Support on the Bitcoin Blockchain

The POS platform supports Bitcoin's Layer 2 and Lightning Network, which are both optimized for instant transactions, as well as for low-value, high-volume transactions that may not always be practical to use on Bitcoin's Layer 1 blockchain. The present embodiment relates to a payments solution that integrates Lightning Network support on the Bitcoin blockchain. The solution provides fast, secure, and cost-effective payments using the Lightning Network, while leveraging the benefits of the Bitcoin blockchain for settlement.

The Bitcoin blockchain is a decentralized digital ledger that enables secure and trustless transactions without the need for intermediaries. However, the transaction throughput of the Bitcoin network is limited, which can result in slow and expensive transactions, especially during times of high network congestion. The Lightning Network is a layer-two scaling solution that enables faster and cheaper transactions on top of the Bitcoin blockchain. However, integrating Lightning Network support with a payment solution can be challenging due to the complexity of the technology.

The payments solution described herein integrates Lightning Network support with the Bitcoin blockchain to provide fast, secure, and cost-effective payments. The solution comprises a user interface that allows users to send and receive payments using Lightning Network channels, a backend system that manages the Lightning Network nodes, and a settlement system that settles transactions on the Bitcoin blockchain. The solution leverages the benefits of the Lightning Network for fast and cheap payments while maintaining the security and trustlessness of the Bitcoin blockchain.

The payments solution comprises a user interface that allows users to create and manage Lightning Network channels. The user interface displays the available balance in the Lightning Network channels and enables users to initiate payments to other users on the network. The user interface also allows users to withdraw funds from the Lightning Network channels to their Bitcoin wallets. The backend system manages the Lightning Network nodes and ensures that the Lightning Network channels are operational and balanced. The backend system also handles the routing of payments between Lightning Network nodes to ensure that payments are delivered quickly and efficiently. The settlement system monitors the Lightning Network channels and settles transactions on the Bitcoin blockchain when necessary. The settlement system ensures that the Bitcoin blockchain remains the ultimate arbiter of transactions and that the Lightning Network nodes are operating within the rules of the Bitcoin protocol.

The payments solution also includes a security system that ensures the integrity and confidentiality of the transactions. The security system comprises multi-factor authentication, encryption, and other security measures to protect against unauthorized access and fraud. The payments solution described herein provides a fast, secure, and cost-effective way to send and receive payments using Lightning Network channels on the Bitcoin blockchain. The solution leverages the benefits of the Lightning Network for fast and cheap payments while maintaining the security and trustlessness of the Bitcoin blockchain.

Automated KYC Threshold Functionality:

Regional jurisdictions require transaction reporting above specified amount limits. Yuzu collects this required customer information only when these limits are triggered. The collected information includes name, address, and birthdate. Prior to the transaction starting, this collected information is cross-referenced with jurisdictional national and regional databases for authenticity. Per regulations, the transaction details and customer information are forwarded to regional regulatory bodies (i.e., FinCEN, Fintrac, etc.).

Recurring Payments:

This feature supports a payment model where the consumers authorize the merchant to pull funds from their accounts automatically at regular intervals for the goods and services provided to them on an ongoing basis. This is especially useful for subscription business models; POS platform contains a sophisticated and intelligent recurring payments engine that automatically pulls cryptocurrency from a consumer's wallet at regular intervals via smart contracts which are defined by consumer profile. The merchant can also send automated payment links at regular intervals to enable recurring payments without smart contract functionality. This functionality allows user seamlessly to integrate recurring payment functionality into consumer life and provides a way to build innovative payment schemes to create value add for merchants and consumers.

Recurring payments are a common feature in the payment industry, allowing users to make regular payments automatically. However, traditional payment methods often involve high transaction fees and long settlement times, which can be a barrier to adoption. Cryptocurrencies offer a faster and more cost-effective payment solution, but currently lack a user-friendly recurring payment feature.

The present embodiment is a system and method for recurring payments using cryptocurrencies. The system comprises a recurring payment engine, a cryptocurrency wallet, and a user interface. The recurring payment engine is responsible for scheduling, executing, and managing recurring payments. The cryptocurrency wallet stores the user's cryptocurrency balance and enables transactions. The user interface allows the user to manage recurring payments and view transaction history.

The recurring payment engine is responsible for scheduling, executing, and managing recurring payments. The engine receives input from the user interface, including payment amount, frequency, and duration. The engine calculates the required cryptocurrency balance for each payment and initiates the transaction using the cryptocurrency wallet. The engine also monitors payment status and handles any failed transactions or payment errors.

The cryptocurrency wallet is responsible for storing the user's cryptocurrency balance and facilitating transactions. The wallet communicates with the recurring payment engine to execute transactions on behalf of the user. The wallet also manages the user's cryptocurrency balance and updates it after each payment transaction.

The user interface provides the user with an easy-to-use interface for managing recurring payments. The interface allows the user to view payment history, modify payment details, and cancel recurring payments. The user interface also provides real-time updates on payment status and balance information.

The present embodiment provides a fast and cost-effective solution for recurring payments using cryptocurrencies. It eliminates the need for third-party payment processors and reduces transaction fees. The user-friendly interface makes it easy for users to manage recurring payments, increasing adoption and usage of cryptocurrencies.

The present embodiment provides a novel solution for recurring payments using cryptocurrencies. It offers a faster, more cost-effective, and user-friendly alternative to traditional payment methods. The recurring payment engine, cryptocurrency wallet, and user interface work together seamlessly to provide a comprehensive and efficient recurring payment system.

eCommerce Payment Enablement:

The POS platform's e-commerce plugin with cryptocurrency payment functionality support provides a seamless and secure payment experience for customers while allowing store owners to expand their payment options and potentially reach a wider audience of cryptocurrency users. The POS platform's plugin support typically provides the following functionality:
The POS platform plugin integrates with the POS platform's cryptocurrency to fiat payment gateway allowing customers to pay for products or services using cryptocurrency.
Automatic currency conversion: The POS platform's plugin automatically converts the store's default currency or any other supported currency into a cryptocurrency payment.
Secure e-commerce transactions: The plugin ensures that cryptocurrency transactions are secure and protected against fraud and hacking.
Payment tracking and reporting: The POS platform plugin allows the store owner to track goods payments and generate reports on sales and transactions.
Refund and dispute management: The POS platform plugin provides functionality for managing refunds, handling chargebacks in cryptocurrency transactions, and disputes related to cryptocurrency payments using the sophisticated POS platform.

Intelligent Automated Onboarding Process:

The intelligent automated onboarding process is a system that uses automation to simplify and speed up the process of onboarding new customers. The goal of an intelligent automated onboarding process is to streamline the customer acquisition process and reduce the time and cost associated with traditional onboarding methods. The key features of the automated onboarding process include but not limited to the:
Digital identity verification: The onboarding process can use digital identity verification tools to verify the identity of new customers. These tools can include facial recognition technology, biometric data, and document verification.
Advanced machine learning algorithms: The onboarding process uses machine learning algorithms to analyze data and make predictions about the likelihood of a customer being a high-risk or low-risk user.
Personalization: The onboarding process can use data analytics to personalize the onboarding experience for each customer. This can include customizing the application process based on the customer's needs and preferences.
Advanced process workflow automation: The automated onboarding process can automate the workflow associated with customer onboarding, such as sending reminders and notifications to customers and support team members.
Compliance: The onboarding process can ensure compliance with regulatory requirements by automating the collection of required documents and relevant data.

Geolocation Capabilities to Ensure Physical Merchant Location is Respected:

The POS platform geolocation capabilities can be used within a platform itself to ensure the physical location of a merchant. By using geolocation technology, the POS platform can verify that a merchant is operating from their registered location and prevent fraudulent activities. The POS platform geolocation capabilities are implemented to ensure the physical merchant location is confirmed and verified:
GPS tracking: The POS platform can use GPS tracking to verify the merchant's location. Merchants are using the mobile application that tracks their location. This allows the POS platform to ensure that the merchant is operating from their registered location.
IP address tracking: The POS platform can use IP address tracking to verify the merchant's location. By using IP address mapping, the platform can determine the location of the device used by the merchant to access the platform. If the merchant's device is not located in the registered location, it can be flagged as suspicious.
Address verification: The onboarding process requires the merchant to verify their address by submitting a document that proves their physical location. The platform can then use geolocation technology to verify that the document matches the physical location of the merchant.
Geofencing: The POS platform can set up geofencing around the registered location of the merchant. Geofencing technology is a virtual boundary created using GPS technology that can trigger an alert when the merchant leaves their registered location. This can help the platform to detect any fraudulent activities or changes in the merchant's location.

By using GPS tracking, IP address tracking, address verification, and geofencing, the POS platform can verify that the merchant is operating from their registered location and maintain compliance with local regulations.

Efficient KYC KYB KYT AML Features within the Platform to Support Different Jurisdictions Compliance Requirements:

The POS platform implements efficient KYC, KYB, KYT, and AML features within the platform which is essential for compliance with regulations and preventing criminal activities. By customizing corresponding workflows, integrating with third-party verification services, using automated risk scoring, implementing real-time monitoring, and adhering to country-specific compliance requirements, platforms can ensure that they are compliant with regulations in different jurisdictions like USA and Canada.
Customizable workflows: Different jurisdictions have different regulatory requirements for KYC, KYB, KYT, and AML. Therefore, the POS platform has customizable workflows that can adapt to different jurisdictions' requirements. The workflows are designed to collect and verify customer information, business information, and transaction details, and identify potentially suspicious activities.
Platform integration with third-party verification services: The POS platform is integrated with third-party verification services that can provide automated identity verification, business verification, and transaction monitoring services. These services ensure that the information provided by the customer or business is accurate, up-to-date, and reliable.
Automated risk scoring: the POS platform uses machine learning algorithms to analyze customer data and identify high-risk customers, businesses, and transactions. This helps the platform to focus the compliance team's attention on the areas that need more attention and scrutiny.
Real-time monitoring: The POS platform implements real-time monitoring of transactions and activities to identify suspicious activities quickly. Real-time monitoring alerts the platform's compliance team of any unusual activities or transactions, allowing them to take action immediately.
Country-specific compliance: The POS platform incorporates country-specific compliance requirements into the company's KYC, KYB, KYT, and AML requirements and features. This includes adhering to the regulations and guidelines issued by different regulatory bodies in different jurisdictions.
Ongoing compliance management: The POS platform implements ongoing compliance management processes to ensure that their KYC, KYB, KYT, and AML features are up-to-date and effective. This includes periodic reviews of compliance processes, training of employees, and conducting audits and assessments.
The use of automated KYC database searching and machine learning algorithms to identify and prevent potential fraud in real-time.
The integration of machine learning algorithms that learn and adapt to new fraud patterns and behavior over time.
The use of secure and encrypted data transmission and storage to protect the privacy of the user's data.
The implementation of a user-friendly interface that allows customers to easily complete KYC verification processes.
The integration of multiple data sources to cross-check and verify user identities and transactions.
The use of real-time monitoring and alerts to identify and prevent suspicious transactions and behavior.
The ability to customize risk thresholds and monitoring rules based on user behavior and transaction history.

Blockchain-Based Cryptocurrency and NFT Rewards System for Merchants and Consumers in a Cryptocurrency Payments Platform

The present embodiment relates to a blockchain-based rewards system for merchants and consumers in a cryptocurrency payments platform. The system uses non-fungible tokens (NFTs) and/or cryptocurrency to reward users for their loyalty and engagement on the platform and provides a secure and transparent way to track rewards and incentivize user behavior. The system leverages the security and transparency of blockchain technology to create a fair and reliable rewards system. The system consists of a set of smart contracts that are deployed on a blockchain.

The smart contracts are responsible for managing the issuance and redemption of rewards, as well as the distribution of NFTs and/or cryptocurrency to users. Merchants can offer rewards to customers for their loyalty and engagement on the platform. The rewards are issued in the form of NFTs and/or cryptocurrency, which can be redeemed for discounts or other incentives on the platform. Consumers can earn NFTs and/or cryptocurrency by participating in various activities on the platform, such as making purchases, referring friends, or leaving reviews. The NFTs and/or cryptocurrency are stored in the user's digital wallet and can be redeemed for rewards offered by merchants. The rewards system uses a consensus mechanism to ensure that all transactions are verified and recorded on the blockchain. This provides a high degree of security and transparency, as all users can view the transaction history and verify the authenticity of the rewards.

In addition, the system uses a decentralized identity system to ensure that users can securely and privately access their rewards and transaction history. This protects user privacy and prevents fraud and identity theft. This embodiment provides a reliable and secure way to incentivize user behavior on a cryptocurrency payments platform. By leveraging the transparency and security of blockchain technology, the rewards system ensures that all users are treated fairly and that rewards are distributed in a transparent and verifiable way.

The blockchain-based NFT and/or cryptocurrency rewards system for merchants and consumers in a cryptocurrency payments platform provides a secure and transparent way to track rewards and incentivize user behavior. The system leverages the security and transparency of blockchain technology to create a fair and reliable rewards system, ensuring that all users are treated fairly and that rewards are distributed in a transparent and verifiable way.

Bitcoin Multi-Chain Bridge

By using a proposed multi-chain bridge, the users can diversify their cryptocurrency holdings across different networks, which can help to reduce risk and increase the overall security of their portfolio and utilize Bitcoin network for payment purposes. For example, a POS platform user could hold Bitcoin on the Bitcoin network, Ethereum on the Ethereum network, and other cryptocurrencies on other networks, and then use a multi-chain bridge to move their assets between networks as needed and pay for merchandise with Bitcoin as a payment mechanism.

A Bitcoin multi-chain bridge is disclosed, which enables the transfer of Bitcoin across multiple blockchain networks within the scope of a payments system. The Bitcoin multi-chain bridge utilizes a smart contract that acts as a bridge between the Bitcoin network and other blockchain networks. The smart contract contains information about the transaction, such as the amount of Bitcoin being transferred, the receiving address, and the network to which the Bitcoin is being transferred. The bridge ensures that the Bitcoin is transferred securely and transparently between the networks.

Bitcoin is a decentralized digital currency that operates on a peer-to-peer network. The Bitcoin network is secured by a public ledger called the blockchain, which records all transactions made on the network. Bitcoin transactions are irreversible and are verified by network nodes through cryptography. However, Bitcoin is limited in its ability to interact with other blockchain networks. For example, it is difficult to transfer Bitcoin to other blockchain networks such as Ethereum, which have different transaction protocols and smart contract capabilities.

The present embodiment is a Bitcoin multi-chain bridge within the scope of a payments system, which enables the transfer of Bitcoin across multiple blockchain networks. The Bitcoin multi-chain bridge utilizes a smart contract that acts as a bridge between the Bitcoin network and other blockchain networks. The smart contract contains information about the transaction, such as the amount of Bitcoin being transferred, the receiving address, and the network to which the Bitcoin is being transferred. The smart contract also includes an algorithm that converts Bitcoin to the appropriate format for the destination network.

The Bitcoin multi-chain bridge ensures that the Bitcoin is transferred securely and transparently between the networks. The bridge is able to track the transaction and confirm its completion, ensuring that the Bitcoin is transferred to the correct address on the destination network. The smart contract is executed on the Bitcoin network, and the transaction is initiated by the sender of the Bitcoin. The sender specifies the amount of Bitcoin to be transferred, the receiving address, and the network to which the Bitcoin is being transferred. The smart contract verifies that the Bitcoin is available for transfer and initiates the conversion algorithm to convert the Bitcoin to the appropriate format for the destination network. The smart contract then sends the converted Bitcoin to the destination network. The Bitcoin multi-chain bridge also ensures that the transaction is transparent and secure. The bridge records the transaction on the blockchain, providing a permanent record of the transaction. The bridge also verifies that the transaction is valid, ensuring that the Bitcoin is transferred securely to the correct address on the destination network.

Mobile Point of Sale (POS) Device with Cryptocurrency Mining Capability

The present embodiment relates to a mobile point of sale (POS) device with the capability to mine cryptocurrency while not in use. The device is equipped with specialized hardware and software that enables it to perform mining operations, while still functioning as a traditional POS device for processing financial transactions. The device is designed to be always connected to a power source and have internet access, allowing for continuous mining operations even when not in use for financial transactions. The device is designed to be compact, portable, and easy to use, with a user interface that enables the device to function as a traditional POS terminal for processing financial transactions. However, in addition to its financial transaction capabilities, the device is also equipped with the ability to mine cryptocurrency.

The mining hardware is integrated into the device and includes a graphics processing unit (GPU) and an application-specific integrated circuit (ASIC). The device is designed to be always connected to a power source and have internet access, allowing for continuous mining operations when not in use for financial transactions. The device is also configured to prioritize financial transaction processing over cryptocurrency mining, ensuring that transactions are processed quickly and efficiently.

The mining software is integrated into the device and includes specialized algorithms that enable the device to mine cryptocurrency while minimizing power consumption and heat generation. The device is also equipped with a cooling system to prevent overheating and extend the life of the mining hardware. The device is able to mine a variety of cryptocurrencies, including Bitcoin, Ethereum, and Litecoin, among others. The mined cryptocurrency can be stored on the device or transferred to a user's digital wallet. The mobile POS device with cryptocurrency mining capability provides a unique solution for merchants and individuals who want to generate additional income through cryptocurrency mining while still utilizing a traditional POS terminal for processing financial transactions.

The mobile POS device with cryptocurrency mining capability provides a novel solution for generating additional income through cryptocurrency mining while still utilizing a traditional POS terminal for processing financial transactions. The device is designed to be compact, portable, and easy to use, with specialized hardware and software that enables it to perform mining operations while minimizing power consumption and heat generation. The de vice is a valuable addition to any merchant or individual seeking to generate additional income through cryptocurrency mining.

Lightning Node Revenue “Yield” Utilizing POS Capabilities

Using spare processing capacity in terminals at the point of sale (POS), a Lightning node is set up to both increase transaction security and collect network fee revenue. The stated node also routes transactions and collects “yield” from other transactions already on the Lightning network. Node operation is complexly automatic and transparent to merchant operations. Private keys for the node are managed remotely.

The present embodiment relates to the field of blockchain technology and more specifically, to a method and system for generating revenue from a lightning node network. Lightning Network is a second-layer payment protocol that runs on top of a blockchain network. Lightning nodes are an essential component of the Lightning Network, which enables users to send and receive off-chain payments. However, there is a lack of incentive for node operators to run and maintain a node, which may lead to a less robust network. Therefore, there is a need for a method and system to incentivize node operators and generate revenue for the network.

The present embodiment provides a method and system for generating revenue from a lightning node network. The method comprises the following steps:
Establishing a payment channel between two or more nodes in the Lightning Network.
Routing payments through the payment channel.
Charging a fee for routing the payment through the payment channel.
Distributing the fee among the nodes that participated in the payment channel.

The present embodiment provides an incentive for node operators to run and maintain a node by enabling them to earn revenue from routing payments through the Lightning Network.

The present embodiment provides a method and system for generating revenue from a Lightning Network by charging a fee for routing payments through a payment channel. The payment channel is established between two or more nodes in the Lightning Network. The payment channel allows users to send and receive off-chain payments through the network.

The payment channel is established by locking a certain amount of bitcoin in a multi-signature address that requires the signatures of both parties to spend the funds. The parties can then send and receive payments between themselves without having to broadcast the transaction to the blockchain network. To route a payment through the Lightning Network, the sender initiates the payment to the recipient through a series of connected nodes in the network. Each node in the path of the payment deducts a small fee for routing the payment through their channel. The fees are aggregated and distributed among the nodes that participated in the payment channel. The fee charged for routing payments through the Lightning Network is determined by the node operator. The fee can be a fixed amount or a percentage of the total payment amount. The fee charged should be competitive enough to attract users to use the Lightning Network for off-chain transactions.

The present embodiment provides a method and system for generating revenue from a Lightning Node Network. The method provides an incentive for node operators to run and maintain a node by enabling them to earn revenue from routing payments through the network. The system provides a more robust network by incentivizing more node operators to participate in the network.

Biometric Extensions for Integrating a Digital Wallet & a POS Platform into the Human Body

The present embodiment relates to biometric extensions for integrating a digital wallet into the human body. This embodiment provides a method and system for securely storing and accessing digital currency and financial data using biometric authentication, enabling convenient and secure transactions without the need for physical devices such as smartphones or credit cards. With the increasing use of digital currency and the need for secure financial transactions, there is a growing demand for innovative methods of storing and accessing digital wallets. Traditional methods such as using a smartphone, or a credit card are prone to security breaches and can be inconvenient for users. The present embodiment addresses these issues by providing a biometric extension for integrating a digital wallet into the human body.

The biometric extension authenticates (KYC) customers and (KYM) merchants using national and global biometric databases. Additionally, the biometric extension interacts with embedded wallets contained inside the customer's body cavity. As digital currency adoption increases, both interfaces above improve ease of use, minimize checkout times, and enable payment security. The biometric extension for integrating a digital wallet into the human body comprises a biometric sensor and a secure storage module. The biometric sensor is configured to capture and authenticate the biometric data of the user, such as fingerprints, iris scans, or facial recognition. The secure storage module is configured to store digital wallet data, including cryptocurrency keys, financial data, and other relevant information. In one embodiment, the biometric sensor and the secure storage module are integrated into a wearable device, such as a smartwatch or a wristband. The wearable device can communicate with other devices through wireless communication protocols, enabling secure and convenient transactions.

In another embodiment, the biometric extension is directly integrated into the human body. The biometric sensor and the secure storage module can be implanted into the user's body, providing a highly secure and convenient way of accessing the digital wallet. The biometric extension can also be configured to include additional security features, such as multi-factor authentication and encryption, to ensure the highest level of security for financial transactions. Biometric extensions for integrating a digital wallet into the human body provide a highly secure and convenient way of storing and accessing digital currency and financial data. The embodiment can be integrated into wearable devices or directly implanted into the human body, enabling seamless and secure financial transactions.

Real Time Settlements to Merchants

The present embodiment relates to a real-time settlement protocol for fiat payments to merchants. More specifically, the embodiment relates to a system and method for instant settlement of fiat payments to merchants. Traditionally, the settlement of fiat payments to merchants is a cumbersome and time-consuming process. Payment processors typically make batch payments and settle them periodically, which can take anywhere from several hours to several days. This delay in settlement can create liquidity and cash flow issues for merchants. In recent years, there has been a growing demand for faster and more efficient payment settlement systems. The emergence of blockchain technology and cryptocurrencies has led to the development of instant settlement protocols for digital assets. However, there remains a need for a real-time settlement protocol for fiat payments to merchants.

The system includes a payment gateway, which receives payment requests from customers and sends them to the payment processor. The payment processor then verifies the payment and sends a settlement request to the settlement system. The settlement system verifies the payment and settles the payment in real-time, sending the funds to the merchant's account. The settlement system utilizes a proprietary algorithm that ensures the settlement of payments in real-time, while minimizing the risk of fraud and chargebacks. The algorithm utilizes a combination of machine learning and artificial intelligence to detect fraudulent transactions and flag them for manual review. The system also includes a user interface, which allows merchants to view their transaction history and account balance in real-time. The user interface also provides merchants with access to a range of analytics and reporting tools, allowing them to track their performance and optimize their business.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system for facilitating conversion between a first type of currency used by a merchant and a second type of currency used by a consumer, comprising:
a Point of Sale (POS) application executed on a first smart device for capturing, by said merchant through a GUI from said POS application displayed on said first smart device, payment information in said first type of currency, said POS application generating and displaying a QR code via said GUI;
wherein said consumer scans said QR code via a second smart device using a digital wallet operating in said second type of currency;
at least one crypto conversion bank coupled to a bank account for said merchant and to said digital wallet from said consumer via said POS application for:
converting, by said at least one crypto conversion bank, said payment from said second type of currency into said first type of currency;
authorizing a transaction; and
transferring funds from said second type of currency from said digital wallet to said bank account for said merchant in said first type of currency.

2. The system of claim 1, wherein said first type of currency is a cryptocurrency and said second type of currency is a traditional government emitted currency.

3. The system of claim 1, wherein a transaction fee is retained from said merchant when said transaction is authorized.

4. The system of claim 1, wherein a transaction fee is retained from said consumer when said transaction is authorized.

5. The system of claim 1, wherein said payment information comprises one or more of merchant information, consumer information and transaction documentation.

6. The system of claim 1, wherein said first smart device comprises one or more of a smartphone, tablet, wearable and a POS payment device.

7. The system of claim 1, wherein said second smart device comprises one or more of a smartphone, tablet, wearable and a POS payment device.

8. The system of claim 1, wherein said transaction is added to an independent software vendor.

9. The system of claim 1, wherein said transaction is added to one or more manufacturer's payment devices.

10. A method to facilitate conversion between a first type of currency used by a merchant and a second type of currency used by a consumer, comprising:
capturing, by said merchant through a GUI from a Point of Sale (POS) application executed on a first smart device, payment information in said first type of currency;
generating a QR code by said POS application;
displaying said QR code via said GUI; and
scanning, by said consumer via a second smart device, said QR code using a digital wallet operating in said second type of currency, wherein at least one crypto conversion bank coupled to a bank account for said merchant and to said digital wallet from said consumer via said POS application for:
converting, by said at least one crypto conversion bank, said payment from said second type of currency into said first type of currency;
authorizing a transaction; and
transferring funds from said second type of currency from said digital wallet to said bank account for said merchant in said first type of currency.

11. The method of claim 10 wherein said first type of currency is a cryptocurrency and said second type of currency is a traditional government emitted currency.

12. The method of claim 10, wherein a transaction fee is retained from said merchant when said transaction is authorized.

13. The method of claim 10, wherein a transaction fee is retained from said consumer when said transaction is authorized.

14. The method of claim 10, wherein said payment information comprises one or more of merchant information, consumer information and transaction documentation.

15. The method of claim 10, wherein said first smart device comprises one or more of a smartphone, tablet, wearable and a POS payment device.

16. The method of claim 10, wherein said second smart device comprises one or more of a smartphone, tablet, wearable and a POS payment device.

17. The method of claim 10, wherein said transaction is added to an independent software vendor.

18. The method of claim 10, wherein said transaction is added to one or more manufacturer's payment devices.
